(19) United States
(12) Patent Application Publication
(10) Pub. No.: US 2005/0256981 A1
(43) Pub. Date: Nov. 17, 2005

(54) PC keystroke elevated mechanism

(76) Inventor: Tung-Chin Lee, Sinjhuang City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/842,516

(22) Filed: May 11, 2004

(51) Int. Cl. G06F 3/00

(52) U.S. Cl. 710/57; 361/680

(57) ABSTRACT

A kind of PC keystroke elevated mechanism comprises an interior supported arm and an exterior supported arm. The interior supported arm possesses a shaft. The exterior supported arm possesses an axial hole. And lateral side of the axial hole locates with bigger assembly hole. Forming interior exterior supported arms, shaft of the interior supported arm extend to assembly hole directly. And then evoking shaft into axial hole by relative pushing or drawing movement of interior/exterior supported arms according relative direction of axial hole and assembly hole. Making interior-exterior supported arms become scissors shape elevated mechanism.

### BACKGROUND OF THE INVENTION

1. Field of the Invention

This invention is about a kind of PC keystroke elevated mechanism, in especial with refers to a kind of raising application of time and space, to promote production and cost down greatly.

2. Description of the Prior Art

According, PC keystroke elevated mechanism is a kind of mechanical structure supporting under keystroke to support user knocking keystroke movement for inputting data into PC conveniently. According folksy PC keystroke elevated mechanism, it principally includes an exterior supported arm and an interior supported arm. The interior-exterior supported arms proceed connecting by a shaft to form a cross elevated mechanism (scissors mechanism). The interior-exterior supported arms can bear keystroke to proceed elevated movement by the shaft. But practically, because every set of keyboard has approximate hundred of keystrokes, must have relatively hundred sets of PC keystroke elevated mechanism for using. So the necessary of PC keystroke elevated mechanism is very large, offering the necessary must by mass-produced method.

The manufacture method of PC keystroke elevated mechanism at present is to make interior supported arm and exterior supported arm of above description individually. Set with shaft on the interior supported arm and set with axial hole on the exterior supported arm. Making completely and combining interior-exterior supported arms, interior supported arm pushes exterior supported arm to two sides and then shaft can integrate axial hole. Nevertheless, because the interior-exterior supported arms themselves are small elements, their structure strength is limited. It is easy to cause deformation or damage of products because of action magnitude or action deflection in the process of unfolding exterior supported arm by interior supported arm. Simultaneity, the interior-exterior supported arms are formed in different production lines and then combined by other assembly equipment, making production operation complexity of traditional PC keystroke elevated mechanism. It will reduce production efficiency and increase production cost.

Hereby showing, the conventional used PC keystroke elevated mechanism mentioned above still has many defects, it's not a good design and need inflict improvement.

Inventor of this case examines defects mentioned above. So think hardly to improve and innovate. Making interior exterior supported arms to proceed formation assembly operation on the same production line. And reduce damage probability. Making assembly of PC keystroke elevated mechanism can proceed big scale production favorably. Will increase outturn effectively-reduce cost.

### SUMMARY OF THE INVENTION

The purpose of this invention is to provide a kind of PC keystroke elevated mechanism. Whose interior supported arm and exterior supported arm can proceed formation-assembly operation on the same production line. Will proceed biggest scale production in unit time-space. Reduce production cost greatly and promote product's good rate.

The other purpose of this invention is to provide a kind of PC keystroke elevated mechanism. Therein assembling interior supported arm and exterior supported arm need not proceed opening or bend movement. Achieving that products will not easy to occur deformation or damage.

Achieving PC keystroke elevated mechanism of invention purposes mention above includes an interior supported arm and an exterior supported arm. The interior supported arm has a shaft. The exterior supported arm has an axial hole. And lateral side of the axial hole set with bigger assembly hole. Between the axial hole and assembly hole is a smooth connection plane. Joint of the axial hole end and assembly hole set with buckled point. Distance between up-down buckled points little less than shaft diameter. So, forming interior exterior supported arms, shaft of the interior supported arm extend to assembly hole directly. And then evoking shaft into axial hole by relative pushing or drawing movement of interior-exterior supported arms according relative direction of axial hole and assembly hole. Making interior-exterior supported arms become scissors shape elevated mechanism.

### BRIEF DESCRIPTION OF THE DRAWINGS

The drawings disclose an illustrative embodiment of the present invention which serves to exemplify the various advantages and objects hereof, and are as follows:

FIG. 1 is stereo drawing of PC keystroke elevated mechanism of this invention;

FIG. 2 is dominative diagram of the PC keystroke elevated mechanism; and

FIG. 3 shows lateral part sectional drawing of the PC keystroke elevated mechanism.

### DETAILED DESCRIPTION OF THE PREFERRED EMBODIMENT

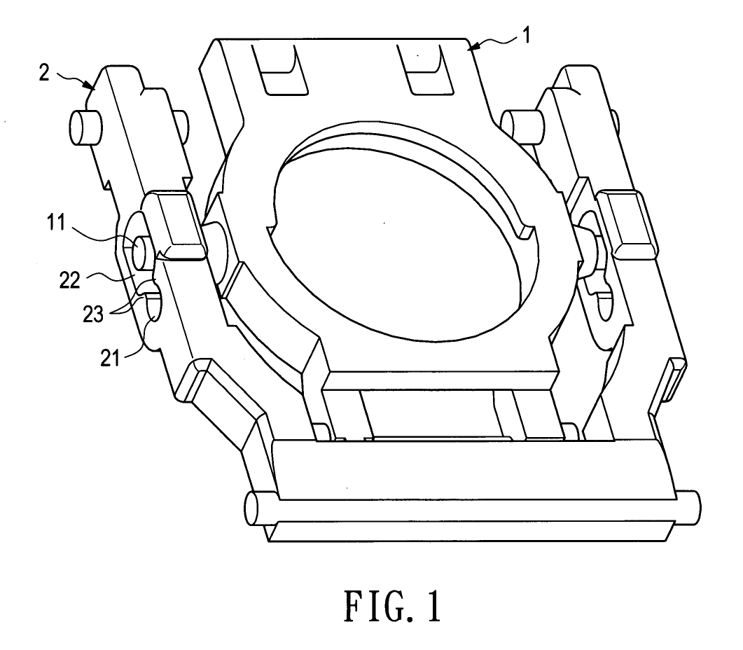

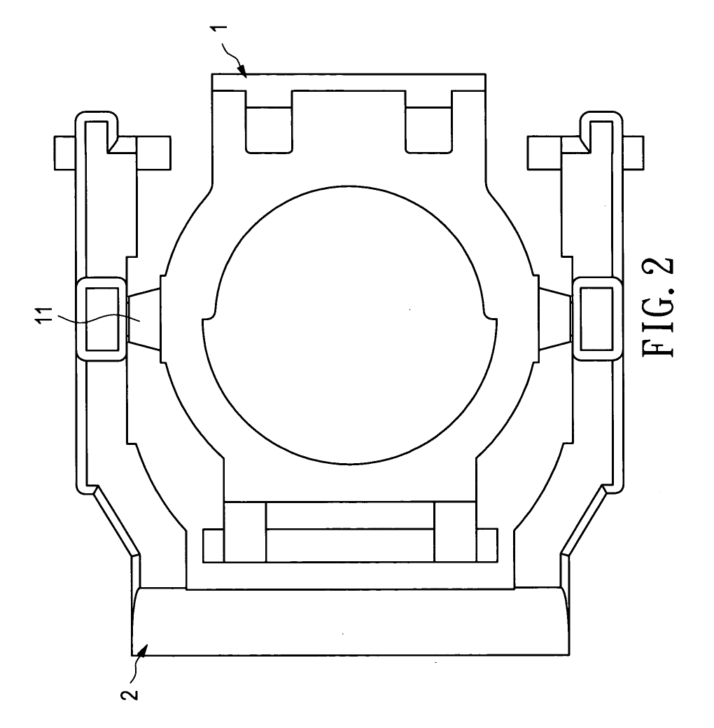

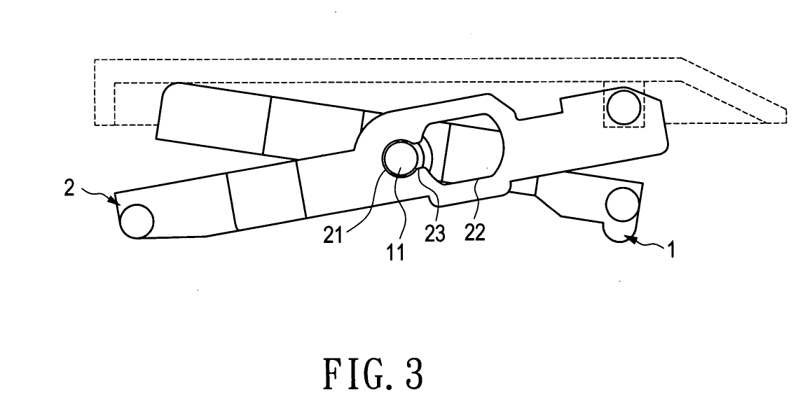

Please refer FIG. 1 to FIG. 3, PC keystroke elevated mechanism offered by this invention principally includes: an interior supported arm 1 and an exterior supported arm 2. The interior supported arm 1 possesses a shaft 11. The exterior supported arm 2 possesses an axial hole 21. And lateral side of the axial hole 21 sets with bigger assembly hole 22. Forming interior-exterior supported arms 1-2, shaft 11 of the interior supported arm 1 extend to assembly hole 22 directly. And then evoking shaft 11 into axial hole 21 by relative pushing or drawing movement (this example is pushing) of interior-exterior supported arms 1-2 according relative direction of axial hole 21 and assembly hole 22. Making interior-exterior supported arms 1-2 become scissors shape elevated mechanism. By the way describe above, making both formation-assembly of interior-exterior supported arms 1-2 is on the same production line. Reduce waste of time and space and reduce cost of production line and portage. Promote outturn and good rate of products greatly.

Pursuing to assemble favorably, between the axial hole 21 and assembly hole 22 of exterior supported arms 2. is a smooth connection plane. Proceeding the shaft 11 to assemble can slip to axial hole 21 from assembly hole 22 to position favorably. Avoiding shaft 11 get wear to promote product quality. In addition, joint of the axial hole 21 end and assembly hole 22 sets with buckled point 23. Distance between up-down buckled points 23 little less than shaft 11 diameter. Combining interior-exterior supported arms 1-2 make shaft 11 to open suitably buckled point 23 from assembly hole 22 to integrate into axial hole 21. And then the buckled point 23 rebounds to original position naturally can constraint shaft's 11 rotation in axial hole 21. Completing connection of this invention.

PC keystroke elevated mechanism offered by this invention described above. Therein interior supported arm and exterior supported arm proceed formation-assembly on the same production line. Reduce cost of production line and portage. Promote application of time and space. And can promote outturn and quality greatly. Reduce cost of product. Simultaneously this invention proceeding assembly, need not proceed movement of interior-exterior supported arms opening outwardly. It will avoid deformation or damage of products. Promote good rate of products.

Many changes and modifications in the above described embodiment of the invention can, of course, be carried out without departing from the scope thereof. Accordingly, to promote the progress in science and the useful arts, the invention is disclosed and is intended to be limited only by the scope of the appended claims.

1. A kind of PC keystroke elevated mechanism, which comprises an interior supported arm and an exterior supported arm, said interior supported arm joining on axial hole of said exterior supported arm by a shaft, whose feature is: lateral side of axial hole of said exterior supported arm setting with bigger assembly hole, while said interior supported arm formed whose said shaft can put in assembly hole, integrate said shaft and axial hole by external force completing location of elevated mechanism.

2. A PC keystroke elevated mechanism as in claim 1, therein setting with smooth connected plane between said assembly hole and axial hole, making said shaft slipping into axial hole favorably but not wear.

3. A PC keystroke elevated mechanism described as in claim 1, therein joint of said axial hole's end and assembly hole setting with buckled point, making said shaft to open buckled point and integrate into said axial hole from assembly hole end, and then said buckled point rebounding to original position to constraint said shaft's rotation in axial hole.

4. A PC keystroke elevated mechanism described as in claim 1, therein said interior exterior supported arms being according relative direction of axial hole and assembly hole, making said shaft to integrate axial hole by movement of pushing or drawing individually.
